(19) United States
(12) Patent Application Publication
(10) Pub. No.: US 2026/0332688 A1
(43) Pub. Date: Oct. 22, 2026

(54) ELECTRONIC INK SCREEN PHONE CASE WITH ANNULAR NFC RECEIVING ANTENNA

(71) Applicant: Shenzhen Wiwood Technology Co., Ltd., Shenzhen (CN)

(72) Inventor: Xiaofeng LI, Shenzhen (CN)

(21) Appl. No.: 19/463,185

(22) Filed: Jan. 29, 2026

(30) Foreign Application Priority Data
Apr. 25, 2025 (CN) 202520799828.1
Jul. 16, 2025 (CN) 202521491232.1
Oct. 22, 2025 (CN) 202522232284.3

(51) Int. Cl. H04M 1/02; G06F 1/16

(52) U.S. Cl. CPC H04M 1/0203; G06F 1/1626

(57) ABSTRACT

An electronic ink screen phone case with an annular NFC receiving antenna, including: a main body of the electronic ink screen phone case, an upper portion of the main body is provided with an opening for avoiding a camera component of a mobile phone. The annular NFC receiving antenna is arranged along a periphery of the opening to form a closed loop. A flexible connecting portion is configured to electrically connect the annular NFC receiving antenna to a circuit board. A display component is configured for displaying images based on data received by the annular NFC receiving antenna; the display component is electrically connected to the circuit board.

### CROSS REFERENCE TO RELATED APPLICATIONS

This application claims foreign priority of Chinese Patent Application No. 202522232284.3, filed on Oct. 22, 2025; No. 202521491232.1, filed on Jul. 16, 2025 and No. 202520799828.1, filed on April 25 in the China National Intellectual Property Administration, the disclosures of all of which are hereby incorporated by reference.

### TECHNICAL FIELD

The present disclosure relates to the technical field of electronic ink screen mobile phone cases, in particular to an electronic ink screen phone case with an annular near field communication (NFC) receiving antenna.

### BACKGROUND

Conventional passive electronic ink screen mobile phone cases generally employ a planar NFC receiving antenna disposed on the back surface of the case, which is overlapped with the built-in NFC receiving antenna of the mobile phone to harvest energy. However, this conventional design suffers from significant drawbacks: the sheet-shaped antenna directly covers the mobile phone's own NFC receiving antenna, which is prone to causing signal shielding and adversely affecting the mobile phone's native functions such as mobile payment.

Furthermore, with the widespread adoption of protruding camera component designs in mobile phones, the available space above the back plate is severely constrained, making it difficult for conventional antennas to avoid the camera component area, resulting in either segmentation of the antenna or insufficient available space.

Moreover, existing NFC receiving antenna designs often fail to adequately consider compatibility with the electronic ink screen and the energy conversion efficiency. The refresh operation of an electronic ink screen requires relatively high instantaneous energy, yet current antenna solutions exhibit low conversion efficiency from NFC signals to refresh energy, frequently leading to refresh failures.

In addition, since mobile phone manufacturers do not disclose the parameters of their built-in NFC receiving antennas, it is difficult for third-party designs to achieve precise impedance matching, resulting in high development costs and poor compatibility across different phone models.

Therefore, there is an urgent need for the electronic ink screen mobile phone case solution that can both address the issues of camera protrusion avoidance and structural compatibility, while improving energy transmission efficiency and communication performance through circuit optimization.

### SUMMARY

The present disclosure provides an electronic ink screen phone case with an annular NFC receiving antenna, the annular NFC receiving antenna is arranged in an annular configuration surrounding the periphery of the camera component opening, thereby avoiding restriction by the camera protrusion and reducing interference with the mobile phone's own NFC function.

To realize the above objective, the present disclosure provides an electronic ink screen phone case with an annular NFC receiving antenna, including: a main body of the electronic ink screen phone case, wherein an upper portion of the main body is provided with an opening or a recess for avoiding a camera component of a mobile phone; the annular NFC receiving antenna, arranged along a periphery of the opening to form a closed loop; a flexible connecting portion, configured to electrically connect the annular NFC receiving antenna to a circuit board; a display component, configured for displaying images based on data received by the annular NFC receiving antenna; the display component is electrically connected to the circuit board.

Furthermore, a projection area of the annular NFC receiving antenna at least partially covers or surrounds a projection area of a built-in NFC receiving antenna of the mobile phone, so as to enable magnetic coupling between the annular NFC receiving antenna and the built-in NFC receiving antenna of the mobile phone.

Furthermore, the closed loop formed by the annular NFC receiving antenna is rectangular, rounded rectangular, circular, or a special-shaped structure adapted to an outer edge of the opening.

Furthermore, the flexible connecting portion is a flexible printed circuit board, extending along an inner wall of the electronic ink screen phone case with the annular NFC receiving antenna.

Furthermore, the display component is an electronic ink screen.

Furthermore, the circuit board integrates a universal electronic ink screen circuit, which is compatible with and optimized for the NFC receiving antenna, the universal electronic ink screen circuit comprising: an NFC main control module and a signal matching module; the annular NFC receiving antenna is a receiving antenna module, connected to an input terminal of the signal matching module; an output terminal of the signal matching module is connected to a signal receiving terminal of the NFC main control module; a driving terminal of the NFC main control module is connected to the display component; the universal electronic ink screen circuit is configured to: in response to the annular NFC receiving antenna capturing an NFC signal from an external NFC device, convert the NFC signal into a current signal, perform capacitance matching through the signal matching module, and transmit the capacitance-matched current signal to the NFC main control module to realize display control of the display component.

Furthermore, the universal electronic ink screen circuit further comprises: a chip power supply module; an input terminal of the chip power supply module is connected to an external direct current (DC) signal source; an output terminal of the chip power supply module is connected to a power supply terminal of the NFC main control module.

Furthermore, the chip power supply module comprises: a first resistor and a fifth capacitor; one terminal of the first resistor is connected to the DC signal source, and the other terminal of the first resistor is connected to a first terminal of the fifth capacitor; the second terminal of the fifth capacitor is connected to the power supply terminal of the NFC main control module.

Furthermore, the NFC main control module comprises an NFC main control chip; a signal receiving terminal of the NFC main control chip is connected to the output terminal of the signal matching module; a driving terminal of the NFC main control chip is connected to a driving input terminal of the display component; a power supply terminal of the NFC main control chip is connected to the second terminal of the fifth capacitor.

Furthermore, the signal receiving terminal of the NFC main control chip comprises a first signal terminal and a second signal terminal; the signal matching module comprises a first capacitor, a second capacitor, a third capacitor and a fourth capacitor; one terminal of the first capacitor is connected to the first signal terminal, and the other terminal is connected to an output terminal of the receiving antenna module; one terminal of the second capacitor is connected to the second signal terminal, and the other terminal is connected to the output terminal of the receiving antenna module; one terminal of the third capacitor is connected to a junction between the first capacitor and the receiving antenna module, and the other terminal is connected to a junction between the second capacitor and the receiving antenna module; one terminal of the fourth capacitor is connected to the junction between the first capacitor and the receiving antenna module, and the other terminal is connected to the junction between the second capacitor and the receiving antenna module.

Furthermore, a first terminal and a second terminal of the annular NFC receiving antenna are connected to the other terminal of the second capacitor; a third terminal and a fourth terminal of the annular NFC receiving antenna are connected to the other terminal of the first capacitor.

Furthermore, the annular NFC receiving antenna is composed of a copper coil.

Furthermore, the circuit board further integrates an electronic ink screen circuit based on NFC passive driving, the electronic ink screen circuit based on NFC passive driving comprising: an NFC receiving antenna circuit for receiving radio frequency signals; a rectification and boosting module, electrically connected to the NFC receiving antenna circuit, configured to rectify the radio frequency signal into a DC signal; an energy storage module, electrically connected to an output terminal of the rectification and boosting module; a power control module, an input terminal of the power control module is electrically connected to the output terminal of the rectification and boosting module, and an output terminal of the power control module is connected to the energy storage module; a direct current-direct current (DC-DC) buck module, an input terminal of the DC-DC buck module is electrically connected to the energy storage module, and an output terminal of the DC-DC buck module is connected to an electronic ink screen driving interface; when the power control module is turned on, the energy storage module is electrically connected to the input terminal of the DC-DC buck module, for stepping down an output voltage of the energy storage module to a driving voltage within a preset range.

Furthermore, the electronic ink screen circuit based on NFC passive driving further comprises an automatic power-off module, an input terminal of the automatic power-off module is electrically connected to the energy storage module, and the automatic power-off module triggers the DC-DC buck module through the energy storage module to cause an enable (EN) pin of the DC-DC buck module to turn off the output.

Furthermore, the rectification and boosting module comprises a radio frequency input port and a plurality of rectification diodes, the radio frequency input port is electrically connected to the electronic ink screen circuit based on NFC passive driving, and input terminals of the plurality of rectification diodes are respectively electrically connected to the radio frequency input port; output terminals of the plurality of rectification diodes respectively form a DC positive pole and a DC negative pole.

Furthermore, the rectification and voltage boosting module comprises a voltage regulation protection diode, an input terminal of the voltage regulation protection diode is connected to the output terminals of the plurality of the rectification diodes, and an output terminal of the voltage regulation protection diode is connected to an input terminal of the power control module, for performing voltage limiting protection on direct currents output from the plurality of the rectification diode, and supplying a controlled DC voltage to the energy storage module.

Furthermore, the energy storage module comprises a plurality of energy storage capacitor groups connected in parallel, the plurality of energy storage capacitor groups are connected to an output terminal of the power control module, and output terminals of the plurality of energy storage capacitor groups are connected to an input terminal of the DC-DC buck module.

Furthermore, an input terminal of the DC-DC buck module is connected to an output terminal of the energy storage module, and an output terminal thereof is connected to the electronic ink screen driving interface; the DC-DC buck module comprises an enable control terminal EN, and when the voltage of the energy storage capacitor group is lower than a threshold value, the DC-DC buck module turns off its output, thereby realizing an automatic power-off function after completion of screen refreshing.

Furthermore, the DC-DC buck module comprises: a DC-DC chip, having an input terminal connected to the output terminal of the energy storage module and an output terminal connected to an input terminal of the electronic ink screen driving interface; an inductor, one terminal of the inductor is connected to a switching output pin of the DC-DC chip, and the other terminal of the inductor is connected to an output node of the DC-DC buck module; a plurality of output filter capacitors connected in parallel, electrically connected to the output node, for smoothing the output voltage of the DC-DC buck module; a voltage dividing resistor, one terminal of the voltage dividing resistor is connected to the output node and the other terminal of the voltage dividing resistor is connected to a feedback pin of the DC-DC chip, for forming a closed-loop regulation of the output voltage.

Furthermore, the DC-DC chip comprises an enable control pin, and the enable control pin is connected to an output terminal of the automatic power-off module; the automatic power-off module is used for monitoring the voltage of the energy storage module, and when it is detected that the energy storage voltage is lower than the threshold value, outputs a turn-off control signal to the enable control pin, so as to cause the DC-DC chip to turn off its output.

Compared with the prior art, the mobile phone case with an electronic ink screen incorporating the annular NFC receiving antenna provided by the present disclosure exhibits the following advantageous effects.

The annular NFC receiving antenna of the present disclosure is arranged annularly around the periphery of the opening, with the central region left vacant, thereby no longer being constrained by the protruding camera component, effectively improving the space utilization efficiency and the overall aesthetic integrity of the mobile phone case design.

By covering or encircling the projection area of the mobile phone's built-in NFC receiving antenna, the closed loop structure is capable of capturing the magnetic flux generated by the mobile phone's NFC receiving antenna. Even with a hollowed-out central area, effective inductive coupling can still be achieved, enabling energy harvesting and data transmission.

The combination of the surrounding arrangement and the projection relationship design ensures that the antenna no longer completely overlaps with the mobile phone's NFC receiving antenna, thereby reducing the possibility of excessive shielding and over-coupling, and consequently enhancing the reliability of the mobile phone's native NFC functionality.

### BRIEF DESCRIPTION OF THE DRAWINGS

In order to more clearly illustrate the technical solutions of the embodiments of the present disclosure, a brief introduction to the accompanying drawings of the embodiments is provided below.

FIG. 1 is an exploded view of an electronic ink screen phone case with an annular NFC receiving antenna according to an embodiment of the present disclosure.

FIG. 2 is a partial exploded schematic view of the electronic ink screen phone case with the annular NFC receiving antenna according to an embodiment of the present disclosure.

FIG. 3 is a schematic diagram showing an usage state of the electronic ink screen phone case with the annular NFC receiving antenna.

FIG. 4 is a schematic structural diagram of the electronic ink screen phone case with the annular NFC receiving antenna according to an embodiment of the present disclosure.

FIG. 5 is a module connection diagram of a universal electronic ink screen circuit according to an embodiment the present disclosure.

FIG. 6 is a circuit schematic diagram of the universal electronic ink screen circuit according to an embodiment of the present disclosure.

FIG. 7 is a schematic diagram illustrating electronic ink screen circuit based on NFC passive driving according to an embodiment of the present disclosure.

FIG. 8 is a circuit diagram showing a DC-DC buck module adapted to different voltage electronic ink screens in the electronic ink screen circuit based on NFC passive driving according to an embodiment of the present disclosure.

### DESCRIPTION OF THE REFERENCE NUMERAL

100 main body, 110 opening, 200 annular NFC receiving antenna, 300 flexible connecting portion, 400 display component, R1 first resistor, C5 fifth capacitor, U1 NFC main control chip, C1 first capacitor, C2 second capacitor, C3 third capacitor, C4 fourth capacitor, NFC_VCC DC signal source.

### DETAILED DESCRIPTION OF THE EMBODIMENTS

The following provides a detailed description of embodiments of the present disclosure. Examples of these embodiments are illustrated in the accompanying drawings, wherein the same or similar reference numerals throughout the specification refer to the same or similar elements or elements having the same or similar functions.

The embodiments described below with reference to the drawings are exemplary only and are intended to explain the present disclosure, and shall not be construed as limiting the present disclosure.

In the description of the present disclosure, it should be understood that terms indicating orientations or positional relationships, such as “upper”, “lower”, “front”, “rear”, “left”, “right”, and the like, are based on the orientations or positional relationships shown in the drawings, and are used merely for the convenience of describing the present disclosure and simplifying the description, and do not indicate or imply that the referred device or element must have a specific orientation, be constructed and operated in a specific orientation, and therefore shall not be construed as limiting the present disclosure.

In the description of the present disclosure, the term “a plurality of” or “several” means one or more, and “multiple” or “a plurality of” means two or more. Expressions such as “greater than”, “less than”, “exceeding” and the like are to be understood as not including the stated number itself, while “above”, “below”, “within” and the like are to be understood as including the stated number itself. The use of terms such as “first” and “second” is solely for the purpose of distinguishing between different technical features and shall not be construed as indicating or implying relative importance, nor shall it imply the number of the indicated technical features or establish any precedence or sequential relationship between the indicated technical features.

Unless otherwise expressly defined, terms such as “disposed”, “mounted”, “connected” and the like in the present description shall be understood in a broad sense. A person skilled in the art may reasonably determine the specific meaning of such terms in the context of the present disclosure in light of the specific technical solution.

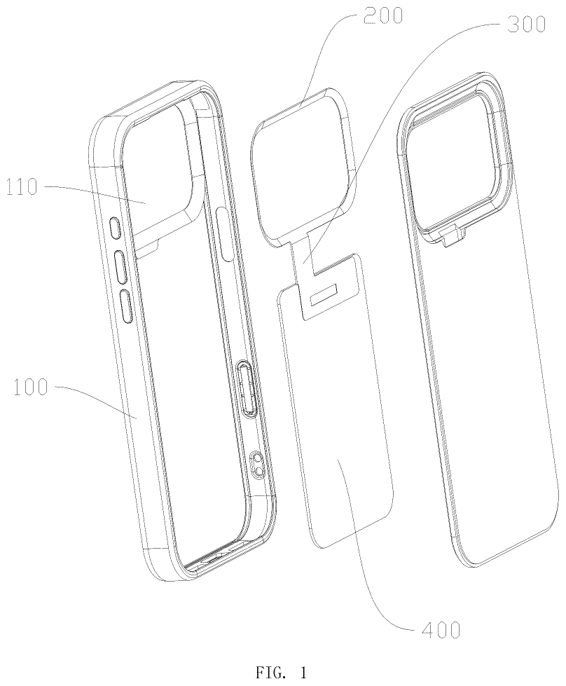

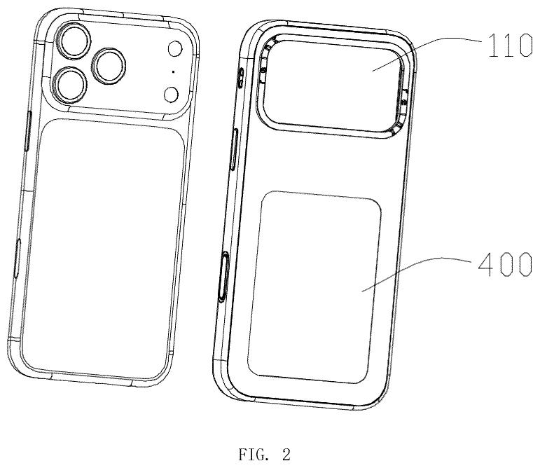

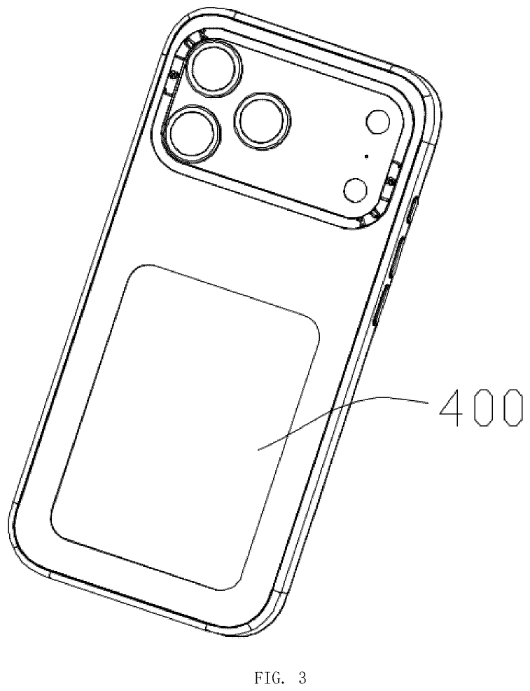

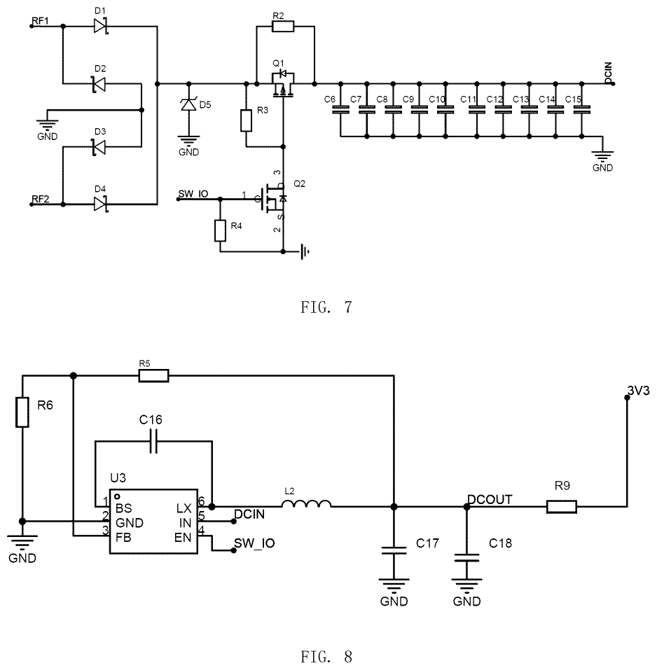

With reference to FIG. 1 through FIG. 8, the following provides a detailed description of an embodiment of the present disclosure directed to an electronic ink mobile phone case incorporating a annular near field communication (NFC) receiving antenna.

As shown in FIG. 1 to FIG. 8, an electronic ink mobile phone case provided in accordance with an embodiment of the present disclosure includes a main body 100. An upper portion of the main body 100 is provided with an opening 110 or a recess 110 configured to avoid interference with a camera component of a mobile phone.

Unlike conventional arrangements in which a planar antenna is disposed so as to cover a back surface of a mobile phone, in the present embodiment, the annular NFC receiving antenna 200 is arranged in a closed loop configuration that extends along the periphery of the opening 110 or recess 110. This arrangement enables the formation of a continuous inductive loop while avoiding any adverse impact on the installation or operation of the camera component.

The annular NFC receiving antenna 200 is electrically connected to a circuit board via a flexible connecting portion 300. Preferably, the flexible connecting portion 300 is implemented as a flexible printed circuit board (FPC) capable of extending along the inner wall of the main body 100 to reach a position of the circuit board. Owing to the excellent bendability of the flexible printed circuit board, stable electrical connection can be maintained during assembly and use, thereby preventing breakage or poor contact caused by mechanical stress.

The circuit board is electrically connected to a display component 400. The display component 400 is preferably an electronic ink screen. When the built-in NFC receiving antenna of the mobile phone generates an alternating magnetic field at the operating frequency, the magnetic field passes through the closed-loop annular NFC receiving antenna 200, thereby inducing a voltage across the antenna. After processing by the circuit board, the induced voltage supplies energy and data signals to the electronic ink screen, enabling refreshing of displayed content. Upon completion of the refresh operation, the electronic ink screen is capable of maintaining the displayed image in the absence of continuous power supply, rendering it particularly suitable for passive power-supply application scenarios.

To further demonstrate the feasibility of the annular NFC receiving antenna 200 arrangement according to the present disclosure, an explanation is provided below from the perspective of electromagnetic induction principles. According to the integral form of Maxwell-Faraday's law of induction:

∫E·dl=−d/dt ∫∫_SB·dS;

where, S represents any open surface bounded by the receiving coil, and B denotes the magnetic flux density generated in space by the built-in NFC receiving antenna of the mobile phone. From the Maxwell-Faraday's law of induction, it follows that the primary factor determining the magnitude of the induced electromotive force across the terminals of the receiving coil is the rate of change of magnetic flux passing through the area enclosed by the closed loop, rather than the filling ratio of conductor material within that area. Accordingly, as long as the receiving coil forms a continuous closed loop and its projection at least partially overlaps with or encircles the projection region of the built-in NFC receiving antenna of the mobile phone, a substantial portion of the near-field magnetic flux generated by the mobile phone NFC receiving antenna can pass through the closed loop. Consequently, an induced voltage and coupled energy of the same type and comparable magnitude to those achievable with conventional overlapping planar antenna arrangements can be obtained at the receiving terminal.

In a near-field magnetic coupling system, the receiving terminal can be equivalently modeled as a resonant branch comprising an inductance L₂, a series resistance R₂, and a matching capacitance C. An alternating current I₁ flowing in the transmitting terminal at angular frequency ω establishes an approximately circular alternating magnetic field in space. The open-circuit induced voltage at the receiving terminal can be expressed as:

V_oc≈jω·M·I₁;

where M represents the mutual inductance between the two coils, satisfying M=k·√(L₁L₂), and k is the coupling coefficient (0<k<1). For a given transmitting terminal configuration and separation distance, the value of k is primarily determined by the geometric encirclement relationship, the area of the closed loop, the relative orientation, and the distance, while being relatively insensitive to whether the central region is hollowed out. In other words, a closed loop arranged around the opening 110 can achieve a mutual inductance M comparable to that of conventional overlapping arrangements, provided that sufficient encirclement area and appropriate projection alignment are maintained.

To compensate for the potential increase in R₂ resulting from the extended loop path length, the present disclosure preferably employs one or more of the following measures: increasing the conductor line width and/or copper thickness, appropriately controlling the number of turns and distributed capacitance, and utilizing a matching network to tune the equivalent operating point back to the 13.56 MHz resonance frequency. These measures maintain the quality factor Q of the receiving terminal within a target range, thereby maximizing the effective incident power.

A key distinction of the loop-shaped arrangement according to the present disclosure, compared with conventional overlapping planar antenna solutions, lies in that the receiving coil is no longer positioned directly above and solidly covering the transmitting coil, but instead forms a closed loop along the periphery of the opening 110 so as to encircle the high-field region of the transmitting coil.

Since refreshing of the electronic ink screen requires energy only instantaneously and image retention does not demand continuous power supply, the magnetic flux captured by the closed loop can, within a specified attachment distance, be converted via a matching circuit into energy and data signals sufficient to meet the driving threshold, thereby enabling proper system functionality.

In practice, the closed loop formed by the annular NFC receiving antenna is preferably shaped as a rectangle, rounded rectangle, circle, or irregular contour that conforms to the outer contour of the camera island, while ensuring that its projection at least partially overlaps with or encircles the projection area of the built-in mobile phone NFC receiving antenna. This configuration maintains stable coupling while avoiding obstruction of the camera. Furthermore, by additionally disposing thin magnetic flux-guiding sheets in segmented regions along the periphery, magnetic flux can be guided and eddy current losses in metallic components can be suppressed, thereby further improving mutual inductance and coupling consistency.

Furthermore, as the annular NFC receiving antenna 200 is arranged along the periphery of the opening 110, the main body 100 forms a complete opening in the region corresponding to the camera component, allowing the appearance of the camera component to be fully exposed. This opening structure not only eliminates spatial conflict between the annular NFC receiving antenna 200 and the camera component, but also preserves the original design aesthetics and recognizability of the mobile phone camera component. For certain mobile phone models that exhibit strong decorative and brand-specific characteristics in the shape, arrangement, and material finish of the camera component, the opening design according to the present embodiment enables these visual elements to be directly presented.

Consequently, while ensuring normal display functionality of the display component 400, the overall aesthetic appeal and visual harmony of the main body 100 are enhanced. Moreover, by avoiding coverage of the camera region that is typical of conventional back-panel antenna designs, the main body 100 does not appear bulky or monotonous in use; instead, it achieves a unified and clean visual integration with the mobile phone body, better highlighting the design of the camera component. As a result, the product exhibits a more refined and attractive appearance, thereby improving user experience and satisfaction.

Further, a projection area of the annular NFC receiving antenna 200 at least partially overlaps with or surrounds a projection area of an NFC receiving antenna built into the mobile phone. By virtue of such arrangement, even though the central region of the loop is hollowed out due to the presence of the opening 110, magnetic flux lines emitted by the built-in NFC receiving antenna of the mobile phone can still pass through the receiving antenna, thereby enabling effective energy harvesting and data transmission.

Further, the closed loop of the annular NFC receiving antenna 200 may be configured, in accordance with the external contour of the camera component of different mobile phone models, as a rectangular shape, a rounded rectangular shape, a circular shape, or a special-shaped structure adapted to match the outer edge of the opening 110. Regardless of the specific contour adopted for the loop, as long as the loop remains closed and surrounds the opening 110, a stable magnetic flux path can be formed, thereby achieving the desired inductive effect. Such flexible structural design enables adaptation to a variety of different camera component layouts, thereby improving the universality of the product.

As can be seen from the above embodiments, the present disclosure arranges a ring-shaped annular NFC receiving antenna 200 around the periphery of the opening 110, and combines a flexible circuit board connection manner, segmented magnetic conductive sheet arrangement, and impedance matching design, so as to realize stable energy harvesting and data display under passive conditions. This approach not only avoids the influence of conventional sheet-type antennas on the camera and mobile phone NFC functions, but also enhances the adaptability to different models and the overall reliability of use.

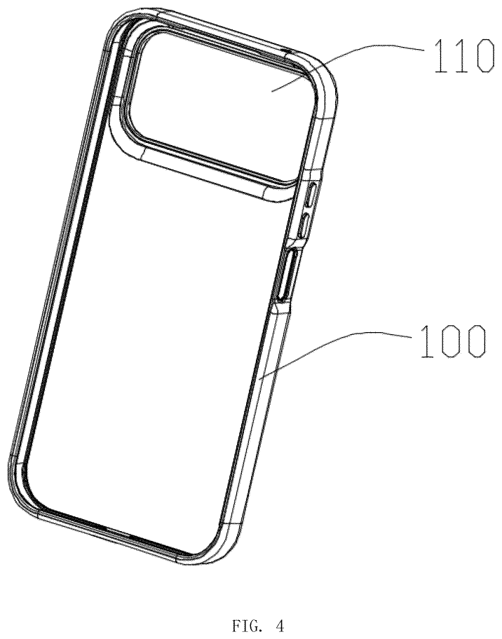

A universal electronic ink screen circuit optimized for NFC receiving antenna adaptation is integrated on the circuit board. Reference is made to FIG. 5, which is a module connection diagram of the NFC receiving antenna adaptation-optimized universal electronic ink screen circuit provided in an embodiment of the present application. The diagram illustrates a plurality of key module designs involved in implementing the present solution, including: an NFC main control module, a signal matching module, and a receiving antenna module, the annular NFC receiving antenna 200 serves as the receiving antenna module, and the display component 400 serves as an electronic ink screen driving module. Each module is described in detail below.

A signal receiving terminal of the NFC main control module is connected to an output terminal of the signal matching module, and a driving terminal of the NFC main control module is connected to an external electronic ink screen driving module.

The NFC main control module constitutes the core control unit of the circuit and is responsible for processing NFC-related signals and data. It is capable of receiving NFC signals (13.56 MHz signals) from an external device and converting them into control signals for driving other modules (such as the electronic ink screen driving module) to perform corresponding operations.

The signal receiving terminal forms part of the NFC main control module and is used to receive the processed NFC signal originating from the signal matching module, which has undergone capacitive matching, filtering, and other processing to ensure signal quality and strength.

The signal matching module is primarily configured to perform capacitive matching and filtering processing on the received NFC signal. Through a resonance circuit and a filter circuit provided therein, the overall impedance of the circuit at the NFC operating frequency is adjusted, thereby achieving capacitive matching between the antenna and the NFC main control chip U1, reducing signal reflection loss, and improving signal transmission efficiency as well as energy utilization efficiency.

The electronic ink screen driving module is an external module responsible for controlling the display operation of the electronic ink screen. It receives driving signals from the NFC main control module and controls the display operation of the electronic ink screen in accordance with these signals.

Specifically, as the core control unit of the circuit, the signal receiving terminal of the NFC main control module is connected to the output terminal of the signal matching module, thereby ensuring reception of optimized NFC signals. More particularly, the signal matching module performs capacitive matching and filtering processing on the received NFC signal so as to improve signal quality and reduce transmission loss, thereby enhancing signal transmission efficiency and stability, while the driving terminal of the NFC main control module is connected to the external electronic ink screen driving module, thereby realizing control and driving of the electronic ink screen. Such design enables the NFC main control module to effectively receive and process signals transmitted by an external NFC device, convert them into control instructions, and consequently control the display operation of the electronic ink screen.

The annular NFC receiving antenna 200 is connected, as the receiving antenna module, to an input terminal of the signal matching module.

Specifically, an output terminal of the receiving antenna module is connected to the input terminal of the signal matching module. This arrangement allows the receiving antenna module to transmit NFC signals received from an external NFC device to the signal matching module, which then performs capacitive matching and filtering processing on these signals to optimize signal quality and reduce transmission loss.

Through such connection manner, the signal matching module is able to effectively receive and process signals coming from the receiving antenna module, thereby ensuring stability and high efficiency of the signals during subsequent transmission.

Further, this embodiment of the present application further comprises a chip power supply module. An input terminal of the chip power supply module is connected to an external DC signal source NFC_VCC. An output terminal of the chip power supply module is connected to a power supply terminal of the NFC main control module.

Specifically, the chip power supply module is provided with a resistor and a capacitor. The capacitor functions to store energy in the circuit and is capable of releasing electrical energy when required, thereby providing short-term high-current support, particularly when a relatively large amount of energy is needed during refresh of the electronic ink screen; the energy storage element can supply the necessary energy to ensure smooth completion of the refresh operation.

More specifically, the capacitor and resistor in the module constitute a simple voltage-dividing and filtering circuit, which is used to stabilize the supply voltage of the DC signal source NFC_VCC, provide a stable power supply to the NFC main control module, and reduce energy waste and circuit instability caused by power supply fluctuations.

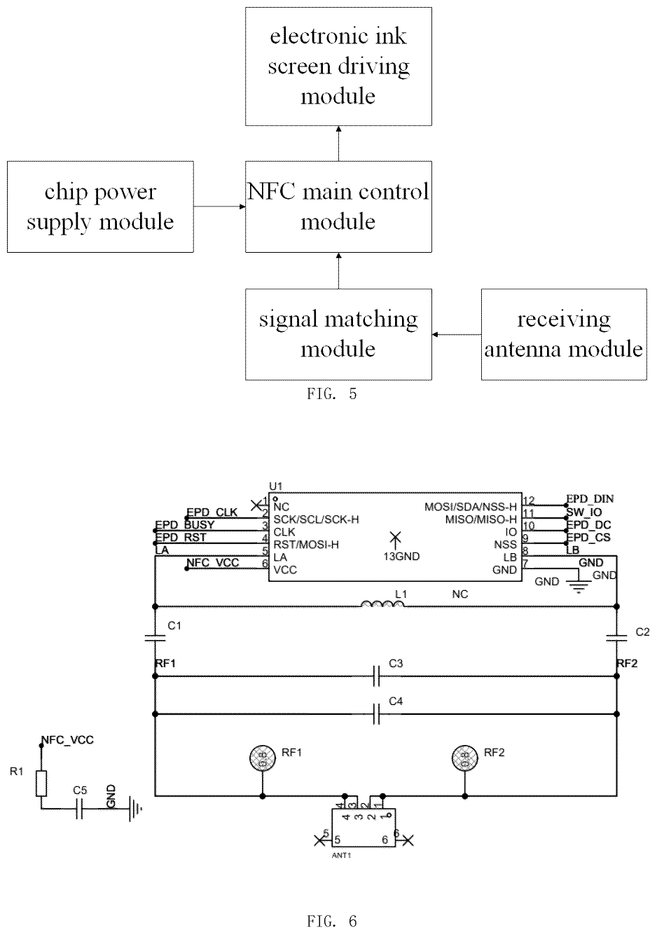

Further, with reference to FIG. 6, which illustrates a schematic circuit diagram of a general electronic ink screen circuit with optimized NFC receiving antenna adaptation according to an embodiment of the present application, the specific device connections of each module are described in detail below in conjunction with FIG. 6.

The chip power supply module comprises: a first resistor R1 and a fifth capacitor C5. One terminal of the first resistor R1 is connected to the DC signal source NFC_VCC, and the other terminal of the first resistor R1 is connected to a first terminal of the fifth capacitor C5. A second terminal of the fifth capacitor C5 is connected to the power supply terminal of the NFC main control module.

Specifically, the chip power supply module, as an essential portion of the circuit, includes the first resistor R1 and the fifth capacitor C5, which cooperate to ensure that the circuit obtains a stable and appropriate power supply. One terminal of the first resistor R1 is directly connected to the DC signal source NFC_VCC so as to receive a DC voltage from the power source. The other terminal thereof is connected to the first terminal of the fifth capacitor C5, thereby forming part of a voltage-dividing and filtering circuit. The second terminal of the fifth capacitor C5 is directly connected to the power supply terminal of the NFC main control module, thereby providing a stable operating voltage to the NFC main control module.

More specifically, this connection arrangement ensures that, in the power supply path from the DC signal source NFC_VCC to the NFC main control module, current first passes through the first resistor R1 and, after being regulated thereby, enters the fifth capacitor C5. During this process, the first resistor R1 performs current limiting and voltage division functions, while the fifth capacitor C5 serves to filter out noise and voltage fluctuations present in the power supply, thereby providing a smoother and more stable voltage. Ultimately, the processed power supply is delivered through the fifth capacitor C5 to the power supply terminal of the NFC main control module, supplying the necessary energy for operation of the module. Based on the foregoing, the chip power supply module not only stably provides power to the NFC main control module, but also offers a certain degree of protection when power supply fluctuations occur, thereby preventing damage to the module that might otherwise result from abrupt voltage changes.

Further, the NFC main control module includes an NFC main control chip U1. A signal receiving terminal of the NFC main control chip U1 is connected to an output terminal of the signal matching module. A driving terminal of the NFC main control chip U1 is connected to an input terminal of the electronic ink screen driving module. A power supply terminal of the NFC main control chip U1 is connected to the second terminal of the fifth capacitor C5.

Specifically, the core of the NFC main control module is the NFC main control chip U1, which is connected to and communicates with other modules in the circuit through different ports. The signal receiving terminal of the NFC main control chip U1 is connected to the output terminal of the signal matching module. The signal matching module is configured to perform capacitive matching and filtering processing on signals transmitted from the receiving antenna module, thereby ensuring signal quality and strength, and consequently improving transmission efficiency and stability of the signals.

More specifically, the driving terminal of the NFC main control chip U1 is connected to the input terminal of the electronic ink screen driving module, enabling the NFC main control chip U1 to transmit control signals to the electronic ink screen driving module. The electronic ink screen driving module receives these driving signals and controls display content of the electronic ink screen in accordance with the signals, thereby realizing visual presentation of information.

More specifically, the power supply terminal of the NFC main control chip U1 is connected to the second terminal of the fifth capacitor C5. The fifth capacitor C5 performs filtering and voltage stabilization functions in the circuit, ensuring that the NFC main control chip U1 receives a clean and stable operating voltage, thereby guaranteeing normal operation and signal processing capability thereof.

Further, the signal receiving terminal of the NFC main control chip U1 includes a first signal terminal and a second signal terminal; the signal matching module comprises a first capacitor C1, a second capacitor C2, a third capacitor C3, and a fourth capacitor C4. One terminal of the first capacitor C1 is connected to the first signal terminal, and the other terminal thereof is connected to an output terminal of the receiving antenna module. One terminal of the second capacitor C2 is connected to the second signal terminal, and the other terminal thereof is connected to the output terminal of the receiving antenna module. One terminal of the third capacitor C3 is connected to a junction between the first capacitor C1 and the receiving antenna module, and the other terminal thereof is connected to a junction between the second capacitor C2 and the receiving antenna module. One terminal of the fourth capacitor C4 is connected to the junction between the first capacitor C1 and the receiving antenna module, and the other terminal thereof is connected to the junction between the second capacitor C2 and the receiving antenna module.

Specifically, the signal receiving terminal of the NFC main control chip U1 includes two critical portions: the first signal terminal and the second signal terminal. These ports respectively receive signals from the signal matching module, enabling the NFC main control chip U1 to effectively process and respond to communication requests from external NFC devices. More particularly, the module includes the first capacitor C1, the second capacitor C2, the third capacitor C3, and the fourth capacitor C4. One terminal of the first capacitor C1 is connected to the first signal terminal, while the other terminal thereof is connected to the output terminal of the receiving antenna module. Similarly, one terminal of the second capacitor C2 is connected to the second signal terminal, while the other terminal thereof is also connected to the output terminal of the receiving antenna module. Based on this configuration, the two capacitors respectively perform preliminary filtering and conditioning on input signals at the two signal terminals, ensuring that the signals possess higher quality and stability before entering the NFC main control chip U1.

More specifically, the NFC main control chip U1 and the receiving antenna primarily rely on two parallel-connected third capacitor C3 and fourth capacitor C4 to perform resonance matching. The purpose of said resonance matching is to enable the receiving antenna and the NFC main control chip U1 to achieve an optimal operating state at a specific frequency, thereby allowing the antenna to efficiently receive and transmit signals, effectively transferring the received signals to the chip, and at the same time enabling the NFC main control chip U1 to smoothly transmit signals outward through the receiving antenna.

The operating principle of the LC resonant circuit is based on the interaction between inductance and capacitance. At a specific resonant frequency, the inductive reactance of the inductor and the capacitive reactance of the capacitor cancel each other out, causing the total impedance of the circuit to reach a minimum value. This characteristic enables the LC resonant circuit to effectively perform impedance matching, thereby ensuring minimal loss during signal transmission. Based on the above, the adaptability of the circuit is enhanced, allowing better matching with various antennas and NFC devices, thereby improving the overall compatibility and stability of the system. Through appropriate component selection and layout design, the signal matching module can maintain highly efficient signal transmission under different operating conditions.

Further, a first terminal and a second terminal of the annular NFC receiving antenna 200 are connected to the other terminal of the second capacitor C2. A third terminal and a fourth terminal of the annular NFC receiving antenna 200 are connected to the other terminal of the first capacitor C1.

Specifically, the first and second terminals of the annular NFC receiving antenna 200 are electrically connected to the other terminal of the second capacitor C2, while the third and fourth terminals of the annular NFC receiving antenna 200 are electrically connected to the other terminal of the first capacitor C1, thereby providing necessary electrical interfaces for the annular NFC receiving antenna 200 and enabling cooperative operation with the signal matching module.

More specifically, the annular NFC receiving antenna 200 is constituted by a copper coil. The NFC receiving antenna functions to transmit and receive near-field communication signals, and the copper coil serves as the key material foundation constituting said antenna. By winding copper wire into a coil shape, the main body portion of the NFC receiving antenna is formed. During communication between NFC devices, current flows through the copper coil. According to the principle of electromagnetic induction, the copper coil generates a magnetic field in the surrounding space for signal transmission, while simultaneously being capable of sensing changes in external magnetic fields and converting them into electrical signals to realize information reception.

Moreover, compared with conventional flexible printed circuit (FPC) trace antennas, the copper coil can significantly reduce the internal resistance of the antenna, improve energy acquisition efficiency, thereby enhancing the driving capability of the NFC receiving antenna and achieving superior performance.

When the mobile phone activates its NFC function, the built-in antenna of the mobile phone generates an alternating magnetic field. The annular NFC receiving antenna 200 captures the magnetic flux and generates an induced current. The induced current is then processed by the signal matching module composed of capacitors C1-C4, undergoing resonance and filtering optimization, and is transmitted to the NFC main control chip U1 with minimal loss. At the same time, the energy storage module accumulates energy. When the accumulated energy reaches a predetermined threshold, the main control chip U1 utilizes the stored electrical energy to drive the display component 400 to refresh the displayed image. The combination of “annular structure+low-resistance coil+precise matching” perfectly addresses the dual challenges of camera clearance avoidance and power supply efficiency commonly faced by passive electronic ink cellphone cases.

As shown in FIGS. 6 to 8, the circuit board further integrates an electronic ink screen driving circuit based on NFC passive power supply, wherein the electronic ink screen circuit based on NFC passive driving includes: an NFC receiving antenna circuit configured to receive radio frequency signals; a rectification and voltage boosting module electrically connected to the NFC receiving antenna circuit and configured to rectify the radio frequency signals into direct current signals; an energy storage module electrically connected to an output terminal of the rectification and voltage boosting module; a power control module having an input terminal electrically connected to the output terminal of the rectification and voltage boosting module, and an output terminal electrically connected to the energy storage module; a DC-DC buck module having an input terminal of the DC-DC buck module electrically connected to the energy storage module and an output terminal of the DC-DC buck module connected to an electronic ink screen driving interface. When the power control module is turned on, the energy storage module is electrically connected to the input terminal of the DC-DC buck module, so as to step down the output voltage of the energy storage module to a driving voltage within a preset range suitable for driving the electronic ink screen.

The present embodiment aims to provide a completely passive electronic ink screen driving circuit based entirely on NFC energy transmission. Its core objective is to drive various types of electronic ink screen components in a structurally simple, highly energy-efficient, and strongly compatible manner without using any battery or external power supply.

In the present embodiment, NFC radio frequency signals are utilized as the sole energy source; after rectification, a relatively stable DC voltage is provided, and energy is temporarily stored by means of energy storage capacitors. The system determines whether to inject the rectified energy into the energy storage unit through a control circuit, and subsequently the DC-DC buck module outputs an adapted voltage to supply the electronic ink screen, thereby achieving complete passivity, automation, and ultra-low power consumption control of the entire power supply chain.

Specifically, when an external NFC device approaches, the NFC receiving antenna circuit receives a 13.56 MHz radio frequency signal, which is then fed into the rectification and voltage boosting module through the matching circuit. The radio frequency alternating current (AC) signal is converted into a DC voltage by a rectifier diode bridge, and the output is limited to a maximum voltage value by a voltage regulator to ensure safety and reliability. When the main control logic (such as the automatic power-off module or screen refresh trigger signal) activates the power control module to turn on, the rectified output is delivered to the energy storage module through the switching transistor Q1, and the capacitor begins to charge and store energy. After the voltage of the energy storage module rises to a level at which the DC-DC converter can operate, the DC-DC buck module is enabled and starts to operate, generating a stable output voltage to supply power for driving the electronic ink screen circuit based on NFC passive driving to perform screen refresh. Upon completion of the screen refresh operation, the voltage of the energy storage module decreases; when it falls below a threshold value, the system generates a control signal to disable the DC-DC module, thereby achieving automatic power-off and preventing unnecessary energy waste.

The present embodiment relies entirely on NFC radio frequency energy harvesting for power supply, eliminating the need for a battery or wired power connection, and is particularly suitable for sealed, portable, non-replaceable or maintenance-free application scenarios. The present embodiment further eliminates the conventional microcontroller (MCU) and dedicated power management IC, and instead adopts a simple and reliable voltage-based control logic, significantly reducing the number of components and hardware cost.

Through the cooperation between the power control module and the energy storage module, automatic power-off is realized after completion of screen refresh, thereby reducing energy consumption and substantially extending the standby lifetime of the system. The output voltage of the DC-DC module can be adjusted within the range of 1.8V to 5V, enabling compatibility with electrophoretic display components of various brands, sizes, and color depths, thus satisfying diverse product specification requirements. The solution is particularly applicable to electronic shelf labels (ESL), electronic paper name badges, information cards, customized mobile phone cases, and other similar applications, demonstrating excellent platform versatility and significant mass-production value.

Further, the system further includes an automatic power-off module, an input terminal of the automatic power-off module is electrically connected to the energy storage module, and the automatic power-off module is configured to trigger and disable the DC-DC buck module via the energy storage module, thereby turning off the output by pulling the EN pin of the DC-DC module to inactive state.

In a passive NFC-powered system, due to the limited and unstable nature of the harvested energy, if the DC-DC module continues to be powered after screen refresh is completed, the energy storage will be rapidly depleted, resulting in system voltage drop, failure of downstream functions, and possibly even system hang-up or erroneous operation.

To improve system energy efficiency and operational safety, the present embodiment introduces an automatic power-off module between the energy storage module and the DC-DC buck module to monitor the output voltage state of the energy storage module; when the voltage falls below a predetermined threshold, the DC-DC module is automatically disabled. This arrangement prevents over-discharge of the storage capacitor or no-load operation of the DC-DC converter. The control is implemented purely by hardware logic without requiring any MCU intervention.

This structure is especially advantageous for electrophoretic display applications which feature high instantaneous power consumption during refresh and discontinuous operating cycles, effectively prolonging the usable duration of stored energy and avoiding energy waste. When the energy storage capacitor is charged to the set value, the automatic power-off module does not intervene, the EN pin remains at high level, and the DC-DC module operates normally, providing output voltage to the driving interface of the electrophoretic display. After the electrophoretic screen refresh is completed, the load decreases but the DC-DC module continues to operate, causing the energy storage capacitor voltage to gradually decline.

The automatic power-off module continuously monitors the output of the energy storage module. When the voltage drops below the threshold value, it triggers the control logic, causing the automatic power-off module to output a low level to the EN pin of the DC-DC chip, thereby stopping the chip operation and shutting down the output. The system then enters a sleep state awaiting the next NFC energy input, thus avoiding no-load power consumption and output instability of the DC-DC converter. The aforementioned control function can be implemented by low-power hardware circuits such as voltage comparators, resistor divider networks, MOS transistor gate control logic, and the like, without requiring additional MCU intervention.

Further, the rectification and voltage boosting module comprises a radio frequency input port and a plurality of rectifying diodes, the radio frequency input port is electrically connected to the NFC receiving antenna circuit, and input terminals of the plurality of rectifying diodes are respectively electrically connected to the radio frequency input port. Output terminals of the rectifying diodes respectively form a DC positive pole and a DC negative pole.

In the present embodiment, the rectification and voltage boosting module includes a radio frequency input port and preferably four rectifying diodes D1, D2, D3 and D4, forming a full-bridge rectification structure. The radio frequency input port is used for receiving the 13.56 MHz RF AC signal from the NFC receiving antenna circuit, and specifically includes two terminals RF1 and RF2, which are respectively electrically connected to two terminals of the NFC receiving antenna.

The input terminals of the rectifying diodes D1 and D2 are respectively connected to the forward paths of RF1 and RF2, while the input terminals of D3 and D4 are respectively connected to the reverse paths of RF1 and RF2, thereby achieving full-wave rectification. The output terminals of the rectifying diodes collectively form the positive and negative poles of the DC output, the output terminals of D1 and D2 are commonly connected to form the rectified positive voltage node, and the output terminals of the rectifying diodes D3 and D4 are commonly connected to form the negative pole node (i.e., ground). This configuration enables the conversion of high-frequency AC energy from dual-terminal input into a unidirectional, relatively stable DC output voltage. Through the design of this embodiment, effective rectification of the high-frequency AC signal input from the NFC receiving antenna is achieved, providing a stable DC energy source for subsequent energy storage and power management modules.

On the basis of the above embodiments, the rectification and voltage boosting module further includes a voltage clamping protection diode, wherein an input terminal of the voltage clamping protection diode is connected to the output terminal of the rectifying diodes, and an output terminal of the voltage clamping protection diode is connected to the input terminal of the power control module, for performing voltage limiting protection on the DC power output by the rectifying diodes, and supplying the controlled DC voltage to the energy storage module.

In this embodiment, the rectifying and voltage-boosting module is configured to rectify the AC radio frequency signal received by the NFC receiving antenna circuit into a stable DC high voltage output, and includes a bridge rectification structure and a voltage regulation protection circuit. Specifically, the rectifying and voltage-boosting module includes two radio frequency input ports RF1 and RF2, which are respectively connected to two output terminals of the NFC receiving antenna circuit, for receiving a 13.56 MHz radio frequency AC signal. The signal is then inputted to a rectifier diode group. The rectifier diode group includes four diodes D1, D2, D3 and D4, which together constitute a full-wave bridge rectification structure. RF1 is connected to the input terminals of D1 and D4, while RF2 is connected to the input terminals of D2 and D3. The positive pole of the rectified output is formed by commonly connecting the output terminals of D1 and D2, and the negative pole is formed by commonly connecting the output terminals of D3 and D4 and is connected to ground. The rectification circuit is capable of effectively converting the differential RF input signal into a stable unidirectional DC voltage.

In order to prevent the rectified output voltage from becoming excessively high due to energy accumulation, the rectifying and voltage-boosting module further includes a voltage regulation protection diode D5, which is a Zener diode. The anode of D5 is connected to the negative pole of the rectified output, and the cathode thereof is connected to the positive pole of the rectified output. When the rectified output voltage exceeds the Zener voltage threshold of the Zener diode, D5 becomes conductive and releases excess electrical energy, thereby limiting the output voltage not to exceed a predetermined value, thus providing overvoltage protection.

Further, the output terminal of the rectifying and voltage-boosting module is connected to the input terminal of a power control module. The power control module includes a controlled main switching transistor Q1 for selectively delivering the rectified output to an energy storage module. After voltage regulation and protection, the rectified output is supplied, under the control of the on-state of the power control module, to a plurality of parallel-connected energy storage capacitors, thereby completing temporary storage of electrical energy. In this embodiment, the rectifying and voltage-boosting module not only realizes energy conversion from the radio frequency signal to DC voltage, but also possesses overvoltage protection capability, thereby ensuring that the subsequent energy storage module and DC-DC module operate within a safe voltage range, and providing a reliable foundation for passive power supply and energy efficiency control of the system.

On the basis of the above embodiment, the energy storage module includes a plurality of parallel-connected energy storage capacitor groups, the plurality of energy storage capacitor groups are connected to the output terminal of the power control module, and the output terminals of the plurality of energy storage capacitor groups are connected to the input terminal of the DC-DC buck module.

When the NFC receiving antenna receives an effective radio frequency signal, a stable DC high voltage is output after conversion by the rectifying and voltage-boosting module. While the power control module is in the conducting state, the rectified voltage is introduced into the energy storage module, and the plurality of parallel-connected capacitors start charging and storing energy. As the voltage gradually rises to a threshold value, the energy storage module possesses sufficient charge to provide continuous and stable power input to the subsequent DC-DC buck module. During operation of the DC-DC module, the energy storage capacitors discharge slowly, releasing energy to the subsequent circuit, thereby ensuring smooth completion of screen refreshing and other operations.

In this embodiment, the energy storage circuit is used for temporarily storing the DC electrical energy output from the rectifying and voltage-boosting module and providing a stable input voltage for the subsequent DC-DC buck module. The energy storage circuit includes a capacitor group formed by parallel connection of a plurality of capacitors, one terminal of the capacitor group is commonly connected as the positive pole, and the other terminal is commonly connected to ground. Specifically, the capacitor group includes capacitors C6, C7, C8, C9, C10, C11, C12, C13, C14 and C15. Each capacitor in the capacitor group is a chip capacitor having a withstand voltage greater than the maximum value of the rectified output, and typically has a capacitance between 10 μF and 47 μF. The plurality of capacitors is connected in parallel to increase the overall equivalent capacitance and improve the filtering effect. The positive poles of the plurality of capacitors are connected via wires to the output terminal of the power control module (Q1), i.e., the rectified output voltage flows into the energy storage circuit after being controllably conducted, while the negative poles are commonly connected to the system ground.

When the rectifying and voltage-boosting module outputs an effective voltage and the power control module is in the conducting state, the input DC voltage is rapidly stored in the capacitor group. After the DC-DC buck module starts operation, the capacitor group serves as its input power supply, providing continuous and stable high-voltage DC input to support step-down output for driving the electrophoretic ink screen for image refreshing. Owing to the excellent charge/discharge response speed and ripple rejection capability of capacitors, the energy storage structure not only fulfills the power supply function, but also acts as a system voltage stabilizer. By adopting parallel connection, the equivalent capacitance is increased while the equivalent series resistance is reduced, thereby effectively improving voltage holding capability and meeting the instantaneous current demand during electrophoretic screen driving.

Further, the input terminal of the DC-DC buck module is connected to the output terminal of the energy storage module, and the output terminal thereof is connected to the driving interface of the electrophoretic ink screen. The DC-DC buck module includes an enable control terminal EN, and when the voltage of the energy storage capacitor group falls below a threshold value, the DC-DC buck module turns off its output, thereby realizing an automatic power-off function after completion of screen refreshing. The DC-DC buck module includes: a DC-DC chip, whose input terminal is connected to the output terminal of the energy storage module, and whose output terminal is connected to the input terminal of the electrophoretic ink screen driving interface; an inductor, one terminal of which is connected to a switching output pin of the DC-DC chip, and the other terminal of which is connected to an output node of the buck module; a plurality of parallel-connected output filter capacitors electrically connected to the output node for smoothing the output voltage of the DC-DC buck module; a voltage divider resistor, one end of which is connected to the output node, and the other end of which is connected to a feedback pin of the DC-DC chip, for forming closed-loop regulation of the output voltage. The DC-DC chip includes an enable control pin, and the enable control pin is connected to the output terminal of an automatic power-off module. The automatic power-off module is configured to monitor the voltage of the energy storage module, and when detecting that the energy storage voltage is lower than a threshold value, to output a turn-off control signal to the enable control pin, thereby causing the DC-DC chip to turn off its output.

In this embodiment, the DC-DC buck module is configured to convert the high voltage output from the energy storage module into a low voltage suitable for operation of the electrophoretic display (electronic ink screen) and to provide a stable power supply output. The module employs a synchronous rectification buck topology and internally includes a DC-DC controller chip, an inductor, output filter capacitors, a feedback resistor network, and enable control logic. The input terminal of a synchronous rectification buck controller chip is electrically connected to the output terminal of the energy storage module so as to receive the DC supply voltage from the energy storage capacitor bank. The output terminal of the DC-DC chip is connected, via its switching node pin (LX pin), to one terminal of the inductor. The other terminal of the inductor is connected to the output node (DCOUT) of the DC-DC buck module, thereby forming a basic buck energy transfer path.

The output node of the DC-DC buck module is further connected in parallel with filter capacitor C17 and filter capacitor C18, which function to smooth the pulsed output current into a stable DC voltage. The parallel configuration of multiple capacitors effectively improves the filtering performance, reduces output ripple, and enhances the voltage transient response capability. In order to achieve closed-loop voltage regulation, the output node is further connected to a pair of series-connected voltage-dividing resistors R5 and R6. One terminal of the resistor pair is connected to the output node, while the other terminal is connected to ground. The voltage division node between the two resistors is connected to the feedback pin (FB pin) of the buck controller chip. This arrangement enables the chip to detect the output voltage in real time, compare it with an internal reference voltage, and dynamically adjust the pulse width modulation (PWM) duty cycle, thereby maintaining the output voltage stable at a predetermined target value.

Furthermore, in order to control the start-up and shutdown of the controller chip, the buck chip is provided with an enable control terminal (EN pin). The EN pin is connected to a main control signal line or to the output terminal of an automatic power-off module. By default, when the EN pin is pulled high, the chip is enabled and operates normally. When the automatic power-off module detects that the energy storage voltage falls below a threshold value, it outputs a low level to the EN pin, thereby disabling the chip and placing the module into a standby state. Through the structural design of this embodiment, the DC-DC buck module not only realizes efficient and stable voltage conversion, but also possesses controllable activation, automatic power-off protection, and multi-voltage output capability, making it suitable for supplying power to different types of electrophoretic displays. Thus, it constitutes a key energy regulation module within the system.

The above description merely illustrates preferred embodiments of the present disclosure. It should be noted that, for those skilled in the art, various modifications and substitutions may be made without departing from the technical principles of the present disclosure, and such modifications and substitutions shall also fall within the protection scope of the present disclosure.

What is claimed is:

1. An electronic ink screen phone case with an annular near field communication (NFC) receiving antenna, comprising:
a main body of the electronic ink screen phone case, wherein an upper portion of the main body is provided with an opening or a recess for avoiding a camera component of a mobile phone;
the annular NFC receiving antenna, arranged along a periphery of the opening to form a closed loop;
a flexible connecting portion, configured to electrically connect the annular NFC receiving antenna to a circuit board;
a display component, configured for displaying images based on data received by the annular NFC receiving antenna; the display component is electrically connected to the circuit board.

2. The electronic ink screen phone case with the annular NFC receiving antenna according to claim 1, wherein a projection area of the annular NFC receiving antenna at least partially covers or surrounds a projection area of a built-in NFC receiving antenna of the mobile phone, so as to enable magnetic coupling between the annular NFC receiving antenna and the built-in NFC receiving antenna of the mobile phone.

3. The electronic ink screen phone case with the annular NFC receiving antenna according to claim 1, wherein the closed loop formed by the annular NFC receiving antenna is rectangular, rounded rectangular, circular, or a special-shaped structure adapted to an outer edge of the opening.

4. The electronic ink screen phone case with the annular NFC receiving antenna according to claim 1, wherein the flexible connecting portion is a flexible printed circuit board, extending along an inner wall of the electronic ink screen phone case with the annular NFC receiving antenna.

5. The electronic ink screen phone case with the annular NFC receiving antenna according to claim 1, wherein the display component is an electronic ink screen.

6. The electronic ink screen phone case with the annular NFC receiving antenna according to claim 1, wherein the circuit board integrates a universal electronic ink screen circuit, which is compatible with and optimized for the NFC receiving antenna, the universal electronic ink screen circuit comprising:
an NFC main control module and a signal matching module;
wherein the annular NFC receiving antenna is a receiving antenna module, connected to an input terminal of the signal matching module;
an output terminal of the signal matching module is connected to a signal receiving terminal of the NFC main control module;
a driving terminal of the NFC main control module is connected to the display component;
the universal electronic ink screen circuit is configured to: in response to the annular NFC receiving antenna capturing an NFC signal from an external NFC device, convert the NFC signal into a current signal, perform capacitance matching through the signal matching module, and transmit the capacitance-matched current signal to the NFC main control module to realize display control of the display component.

7. The electronic ink screen phone case with the annular NFC receiving antenna according to claim 6, wherein the universal electronic ink screen circuit further comprises:
a chip power supply module;
wherein an input terminal of the chip power supply module is connected to an external direct current (DC) signal source;
an output terminal of the chip power supply module is connected to a power supply terminal of the NFC main control module.

8. The electronic ink screen phone case with the annular NFC receiving antenna according to claim 7, wherein the chip power supply module comprises:
a first resistor and a fifth capacitor;
wherein one terminal of the first resistor is connected to the DC signal source, and the other terminal of the first resistor is connected to a first terminal of the fifth capacitor;
the second terminal of the fifth capacitor is connected to the power supply terminal of the NFC main control module.

9. The electronic ink screen phone case with the annular NFC receiving antenna according to claim 8, wherein the NFC main control module comprises an NFC main control chip;
wherein a signal receiving terminal of the NFC main control chip is connected to the output terminal of the signal matching module;
a driving terminal of the NFC main control chip is connected to a driving input terminal of the display component;
a power supply terminal of the NFC main control chip is connected to the second terminal of the fifth capacitor.

10. The electronic ink screen phone case with the annular NFC receiving antenna according to claim 9, wherein the signal receiving terminal of the NFC main control chip comprises a first signal terminal and a second signal terminal;
the signal matching module comprises a first capacitor, a second capacitor, a third capacitor and a fourth capacitor;
one terminal of the first capacitor is connected to the first signal terminal, and the other terminal is connected to an output terminal of the receiving antenna module;
one terminal of the second capacitor is connected to the second signal terminal, and the other terminal is connected to the output terminal of the receiving antenna module;
one terminal of the third capacitor is connected to a junction between the first capacitor and the receiving antenna module, and the other terminal is connected to a junction between the second capacitor and the receiving antenna module;
one terminal of the fourth capacitor is connected to the junction between the first capacitor and the receiving antenna module, and the other terminal is connected to the junction between the second capacitor and the receiving antenna module.

11. The electronic ink screen phone case with the annular NFC receiving antenna according to claim 10, wherein a first terminal and a second terminal of the annular NFC receiving antenna are connected to the other terminal of the second capacitor;
a third terminal and a fourth terminal of the annular NFC receiving antenna are connected to the other terminal of the first capacitor.

12. The electronic ink screen phone case with the annular NFC receiving antenna according to claim 11, wherein the annular NFC receiving antenna is composed of a copper coil.

13. The electronic ink screen phone case with the annular NFC receiving antenna according to claim 1, wherein the circuit board further integrates an electronic ink screen circuit based on NFC passive driving, the electronic ink screen circuit based on NFC passive driving comprising:
an NFC receiving antenna circuit for receiving radio frequency signals;
a rectification and boosting module, electrically connected to the NFC receiving antenna circuit, configured to rectify the radio frequency signal into a DC signal;
an energy storage module, electrically connected to an output terminal of the rectification and boosting module;
a power control module, an input terminal of the power control module is electrically connected to the output terminal of the rectification and boosting module, and an output terminal of the power control module is connected to the energy storage module;
a direct current-direct current (DC-DC) buck module, an input terminal of the DC-DC buck module is electrically connected to the energy storage module, and an output terminal of the DC-DC buck module is connected to an electronic ink screen driving interface;
wherein when the power control module is turned on, the energy storage module is electrically connected to the input terminal of the DC-DC buck module, for stepping down an output voltage of the energy storage module to a driving voltage within a preset range.

14. The electronic ink screen phone case with the annular NFC receiving antenna according to claim 13, wherein the electronic ink screen circuit based on NFC passive driving further comprises an automatic power-off module, an input terminal of the automatic power-off module is electrically connected to the energy storage module, and the automatic power-off module triggers the DC-DC buck module through the energy storage module to cause an enable (EN) pin of the DC-DC buck module to turn off the output.

15. The electronic ink screen phone case with the annular NFC receiving antenna according to claim 13, wherein the rectification and boosting module comprises a radio frequency input port and a plurality of rectification diodes, the radio frequency input port is electrically connected to the electronic ink screen circuit based on NFC passive driving, and input terminals of the plurality of rectification diodes are respectively electrically connected to the radio frequency input port;
wherein output terminals of the plurality of rectification diodes respectively form a DC positive pole and a DC negative pole.

16. The electronic ink screen phone case with the annular NFC receiving antenna according to claim 15, wherein the rectification and voltage boosting module comprises a voltage regulation protection diode, an input terminal of the voltage regulation protection diode is connected to the output terminals of the plurality of the rectification diodes, and an output terminal of the voltage regulation protection diode is connected to an input terminal of the power control module, for performing voltage limiting protection on direct currents output from the plurality of the rectification diode, and supplying a controlled DC voltage to the energy storage module.

17. The electronic ink screen phone case with the annular NFC receiving antenna according to claim 16, wherein the energy storage module comprises a plurality of energy storage capacitor groups connected in parallel, the plurality of energy storage capacitor groups are connected to an output terminal of the power control module, and output terminals of the plurality of energy storage capacitor groups are connected to an input terminal of the DC-DC buck module.

18. The electronic ink screen phone case with the annular NFC receiving antenna according to claim 17, wherein an input terminal of the DC-DC buck module is connected to an output terminal of the energy storage module, and an output terminal thereof is connected to the electronic ink screen driving interface;
wherein the DC-DC buck module comprises an enable control terminal EN, and when the voltage of the energy storage capacitor group is lower than a threshold value, the DC-DC buck module turns off its output, thereby realizing an automatic power-off function after completion of screen refreshing.

19. The electronic ink screen phone case with the annular NFC receiving antenna according to claim 13, wherein the DC-DC buck module comprises:
a DC-DC chip, having an input terminal connected to the output terminal of the energy storage module and an output terminal connected to an input terminal of the electronic ink screen driving interface;
an inductor, one terminal of the inductor is connected to a switching output pin of the DC-DC chip, and the other terminal of the inductor is connected to an output node of the DC-DC buck module;
a plurality of output filter capacitors connected in parallel, electrically connected to the output node, for smoothing the output voltage of the DC-DC buck module;
a voltage dividing resistor, one terminal of the voltage dividing resistor is connected to the output node and the other terminal of the voltage dividing resistor is connected to a feedback pin of the DC-DC chip, for forming a closed-loop regulation of the output voltage.

20. The electronic ink screen phone case with the annular NFC receiving antenna according to claim 19, wherein the DC-DC chip comprises an enable control pin, and the enable control pin is connected to an output terminal of the automatic power-off module;
wherein the automatic power-off module is used for monitoring the voltage of the energy storage module, and when it is detected that the energy storage voltage is lower than the threshold value, outputs a turn-off control signal to the enable control pin, so as to cause the DC-DC chip to turn off its output.
